(19) United States
(12) Patent Application Publication
(10) Pub. No.: US 2026/0081284 A1
(43) Pub. Date: Mar. 19, 2026

(54) FRAME MOUNTED BATTERY SYSTEM

(71) Applicant: Alliance North America, Inc., Henderson, NV (US)

(72) Inventors: Michael Yin, Henderson, NV (US); Steven Cox, Henderson, NV (US); Travis Waineo, Henderson, NV (US)

(21) Appl. No.: 19/330,009

(22) Filed: Sep. 16, 2025

Related U.S. Application Data
(60) Provisional application No. 63/695,562, filed on Sep. 17, 2024.

(51) Int. Cl. H01M 50/249; B60R 16/04; H01M 50/242; H01M 50/262; H01M 50/271

(52) U.S. Cl. CPC H01M 50/249; B60R 16/04; H01M 50/242; H01M 50/262; H01M 50/271; H01M 2220/20

(57) ABSTRACT

A trailer mounted battery system that includes a trailer frame and a low-profile battery. The trailer frame includes a pair of side rails. The low-profile battery mounts within the trailer frame. The trailer frame retains and supports a generator above the low-profile battery. The low-profile battery mounts between the side rails of the trailer frame. The top surface of the low-profile battery does not extend above a maximum height of the side rails of the trailer frame. The low-profile battery includes one or more battery packs. The battery packs are arranged side-by-side along the trailer frame and between the side rails of the trailer frame.

### CROSS REFERENCE TO RELATED APPLICATION

The present invention claims the benefit of U.S. provisional application Ser. No. 63/695,562, filed Sep. 17, 2024, which is hereby incorporated herein by reference in its entirety.

### FIELD OF THE INVENTION

The present invention is directed to battery systems, power generation, system controls, and in particular to battery storage systems in combination with generators in mobile and stationary applications.

### BACKGROUND OF THE INVENTION

Generators are often driven by engines, such as diesel engines, and other engines using a variety of fuels, e.g., propane, natural gas, gasoline, biodiesel, and hydrogen. When properly loaded, a diesel engine provides an efficient driver for a generator, when lightly loaded, diesel engines are susceptible to wet stacking (i.e., when unburnt diesel fuel passes into the diesel exhaust system and produces an oily residue). Wet stacking happens when a diesel engine is running at a low percentage or proportion of its capacity. For example, a diesel engine coupled to a generator is susceptible to wet stacking when the generator it is driving has no load or only a minimal load coupled to it; in addition, the generator operates less efficiently (more fuel is consumed per kwh produced versus an optimally loaded generator). When the generator is operating with no load or only a minimal load, the diesel engine is operating in an inefficient manner, resulting in the risk of wet stacking because the diesel engine is not at a proper operating temperature (allowing unburnt fuel to escape into the diesel exhaust system). Diesel engines are most efficient when they are running at a sufficient percentage or proportion of their full capacity. When a diesel engine is running under a sufficient load, the diesel engine can run at an optimum operating temperature. Generators used to power electrical equipment typically see variable loads through their normal usage intervals. To aid in the prevention of wet stacking of diesel engines coupled to generators, dummy loads or load banks, and battery packs can be applied to their generators. The load banks and/or battery packs provide a load on the generator that is sufficient to prevent wet stacking of the generator's diesel engine. However, battery packs can be large and bulky, requiring additional engineering considerations in mobile generator embodiments.

### SUMMARY OF THE INVENTION

Embodiments of the present invention provide a low-profile battery system for mounting within a trailer frame configured for mounting a generator. The low-profile battery system is configured to mount between side rails of the trailer frame, with the top surface of the low-profile battery system not extending above the height of the side rail. The low-profile battery system includes one or more battery packs that are arranged along the trailer frame. The trailer frame is configured to receive and retain the generator upon the trailer frame.

In an aspect of the present invention, the low-profile battery system includes a plurality of battery packs with at least two battery packs stacked together. The battery packs can be arranged side by side, or in other arrangements.

In another aspect of the present invention, each trailer frame side rail includes at least one removable access cover for access to the batteries arranged on the trailer.

In yet another aspect of the present invention, mounting brackets are arranged along the trailer frame for mounting the generator to the trailer frame.

In a further aspect of the present invention, the trailer frame siderails are configured for mounting the generator directly to the trailer frame via the trailer frame siderails.

In a further aspect of the present invention, the trailer frame rails include mounting rails along bottom edges for mounting battery packs to the trailer frame.

In another aspect of the present invention, a head unit containing inverters, power electronics and controls is mounted on the trailer frame. The head unit controls and manages the operation of the generator and the inverters. The head unit also controls the charge/discharge cycles of the low-profile battery system mounted to the trailer frame.

These and other objects, advantages, purposes, and features of the present invention will become apparent upon review of the following specification in conjunction with the drawings.

### BRIEF DESCRIPTION OF THE DRAWINGS

FIG. 1A is a top-down view of a battery pack and its top cover in accordance with the present invention;

FIG. 1B is a top perspective view of the battery pack of FIG. 1A and illustrating the battery pack enclosure and top cover in accordance with the present invention;

FIG. 1C is a bottom perspective view of the battery pack of FIG. 1A and illustrating the cross members and mounting points in accordance with the present invention;

FIG. 2A is a side view of the battery pack illustrating the base enclosure and cover in accordance with the present invention;

FIGS. 2B and 2C are side views of either end of the battery pack illustrating the fittings and connection points arranged on either side of the battery pack in accordance with the present invention;

FIG. 3 is a perspective view of an exemplary battery pack in accordance with the present invention;

FIG. 4 is a perspective view of a pair of battery packs arranged between the side rails of an exemplary trailer frame in accordance with the present invention;

FIG. 5 is cross-sectional view of an exemplary trailer frame with battery pack illustrating the placement and mounting of the battery pack between the trailer frame rails in accordance with the present invention;

FIG. 6 is a perspective view of an exemplary generator and head unit mounted on a trailer frame that includes one or more battery packs mounted between the trailer frame rails in accordance with the present invention;

FIG. 7A is a cross-sectional view of an exemplary trailer frame with battery pack and generator, and illustrating the placement and mounting of the battery pack between the trailer frame rails and the placement and mounting of the generator upon the trailer frame in accordance with the present invention;

FIG. 7B is a cross-sectional view of an alternative trailer frame with battery pack and generator, and illustrating the placement and mounting of the battery pack between the trailer frame rails and the placement and mounting of the generator upon the trailer frame in accordance with the present invention;

FIG. 8A is a side view of a portion of an exemplary trailer frame with a removable access cover along the side rails in accordance with the present invention;

FIG. 8B is an exemplary removable access cover in accordance with the present invention;

FIG. 9 is a top-down view of an exemplary alternative trailer frame with an exemplary arrangement of mounting points on side rails in accordance with the present invention;

FIG. 10A is a perspective side view of the trailer frame of FIG. 9 with an alternative arrangement of mounting points in accordance with the present invention; and

FIG. 10B is a perspective side view of the trailer frame of FIG. 10A with battery packs installed.

### DESCRIPTION OF THE PREFERRED EMBODIMENTS

Referring to the drawings and the illustrative embodiments depicted therein, a low-profile battery system provides for an efficient and convenient mounting of battery packs upon a trailer frame such that the battery packs are arranged between rails of the trailer frame (“trailer frame rails”), such that a generator can be mounted upon the trailer frame and above the battery backs. In one embodiment, the low-profile battery system includes one or more battery packs. An arrangement of the battery packs can be mounted between the trailer frame rails such that the battery packs do not extend above the height of the trailer frame rails. The battery packs can be mounted side by side, or in other configurations between the trailer frame rails. The trailer frame is configured to receive and retain the generator upon the trailer frame. In one embodiment, an arrangement of mounting brackets is used to mount the generator to the trailer frame. In another embodiment, the generator can be mounted to the trailer frame by mounting directly to the trailer frame rails.

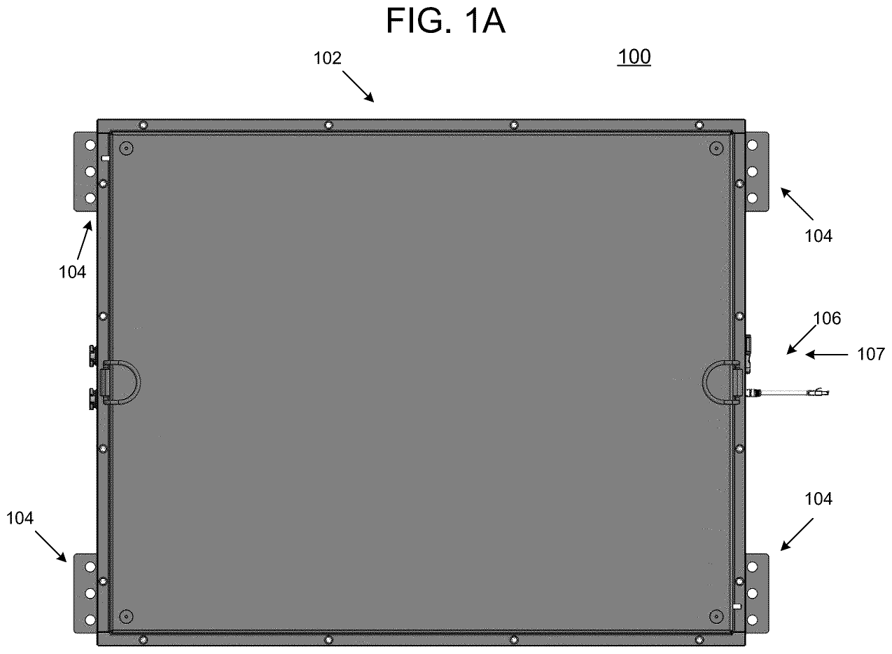

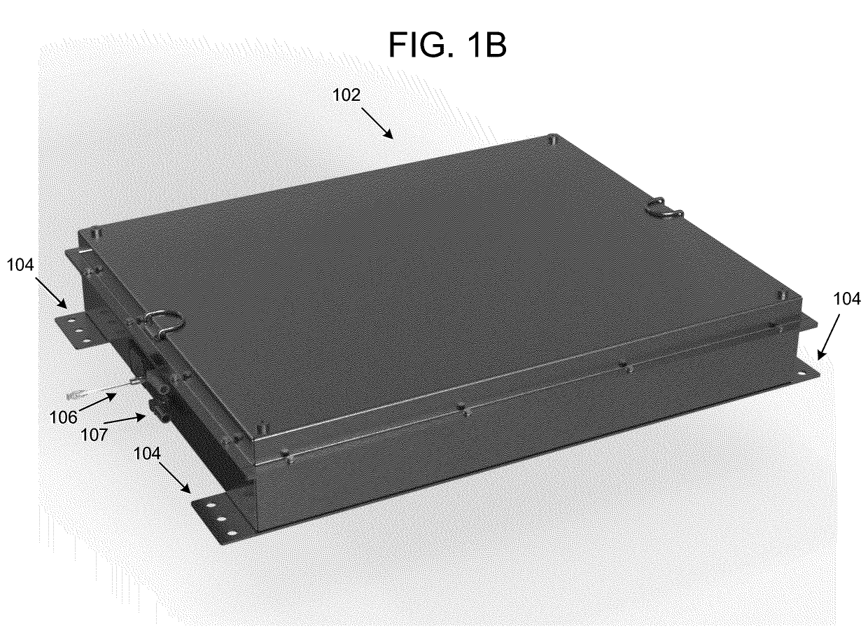

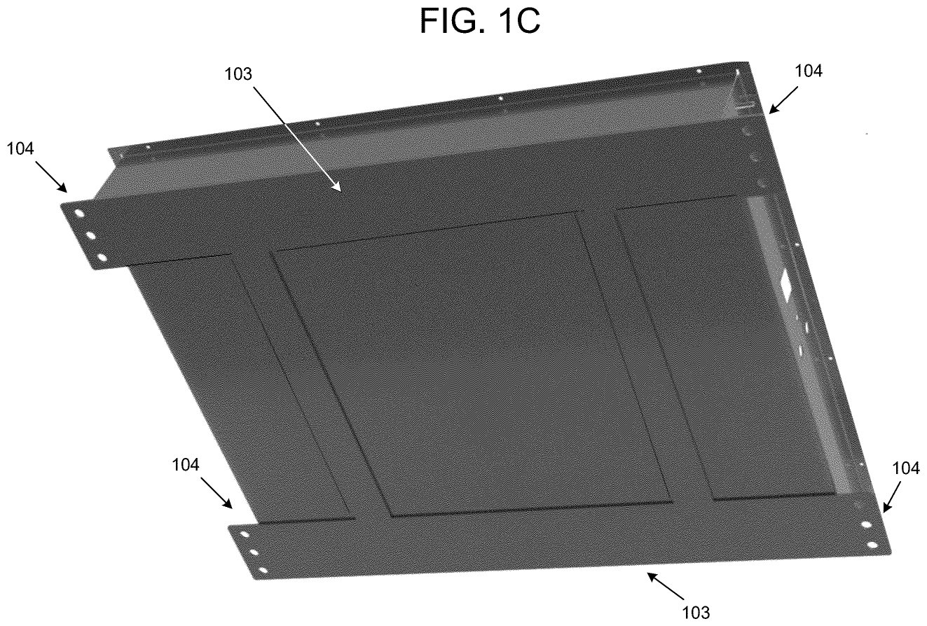

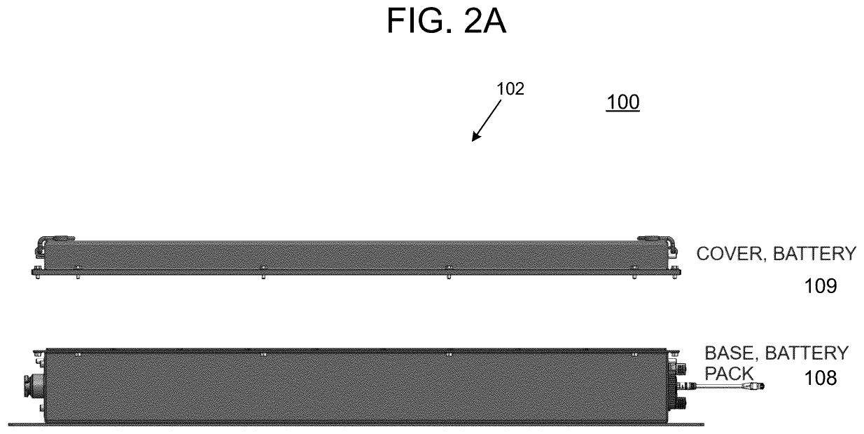

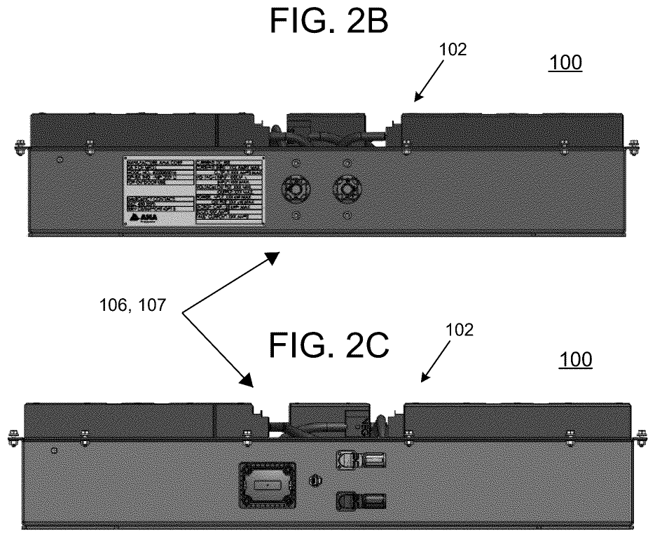

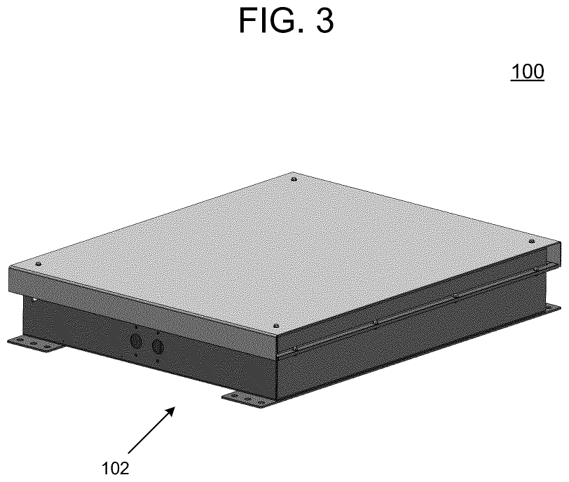

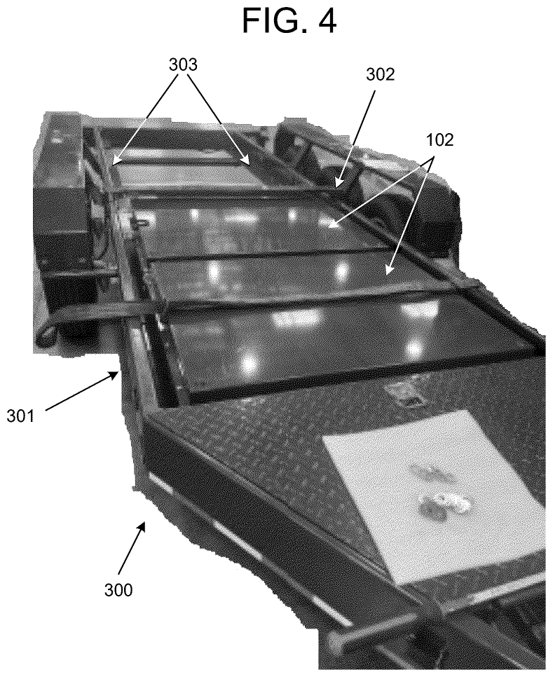

Referring to FIGS. 1A, 1B, 1C, 2A, 2B, 2C, and 3, the low-profile battery system 100 (comprising one or more battery packs 102) includes a battery enclosure. As illustrated in FIGS. 3A, 3B, and 4, in one embodiment, the battery enclosure includes a bottom steel enclosure 108 (which may also be referred to as a “base”) and a removable, bolt-on top cover 109 (which may also be referred to as a “top plate” or as a “cover”). The low-profile battery system 100 further includes a pair of mounting cross members 103 on the underside of each battery pack 102 (on the underside of the enclosure 108) (see FIGS. 2A and 4). In one embodiment, the low-profile battery system 100 comprises battery packs 102, each comprising a plurality of individual battery modules (not illustrated). One or more battery packs 102 may be arranged between the trailer frame side rails 301 of the trailer frame 300 (e.g., a pair of battery packs 102 are illustrated in FIG. 4).

In one embodiment, the battery enclosure (e.g., the bottom steel enclosure 108) includes access portals 106 for a variety of sensors or communications links, as well as a pressure relief vent 107. The pressure relief vent 107 is configured to provide an exhaust vent and/or pressure relief when needed for the battery enclosure (e.g., due to battery outgassing).

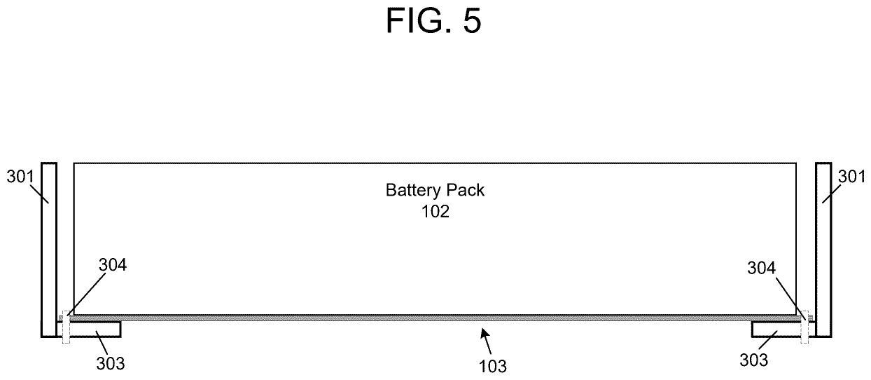

Referring to FIGS. 4-7, each battery pack 102 is mounted to the trailer frame 300, with appropriate mounting hardware 304 (e.g., mounting bolts) at each corner of the battery pack 102 to secure the battery pack 102 to the trailer frame 300. The bottom steel enclosure 108 includes a pair of cross members 103 that include mounting points 104 on each end (see FIGS. 1A, 1B, 1C, and 5). As illustrated in FIGS. 1C, 5, 7A, and 7B, the mounting bolts 304 secure the battery pack 102, via the mounting points 104 on either end of the cross members 103, to trailer frame mounting rails 303 of the trailer frame 300. With the battery pack(s) 102 mounted low on the trailer frame mounting rails 303, a low center of gravity for the trailer frame 300 can be established or maintained. In one exemplary embodiment, each battery pack 102 can weigh up to 1,000 pounds. In addition to providing a low center of gravity, mounting the battery packs 102 upon the trailer frame mounting rails 303 between the trailer frame side rails 301 will provide increased protection for the battery pack(s) 102.

As illustrated in FIGS. 4, 5, 7A, and 7B, an exemplary battery pack 102 will fit between the trailer frame side rails 301 and will not extend above the maximum height of the trailer frame side rails 301. As illustrated in FIGS. 4, 6, and 7A, this allows for the generator 210, in one exemplary embodiment, to be mounted directly to the trailer frame 300 via an arrangement of mounting brackets 302. Thus, the generator (via the mounting brackets 302) will be mounted approximately flush with the top surface of the trailer frame 300 (with the mounting brackets 302 interposed between the side rails 301 of the trailer frame 300 and the generator 210). In one embodiment, the height of the battery pack 102 might extend a negligible length above the maximum height of the trailer frame side rails 301, with the mounting brackets 302 sized to accommodate any variation in the battery pack height.

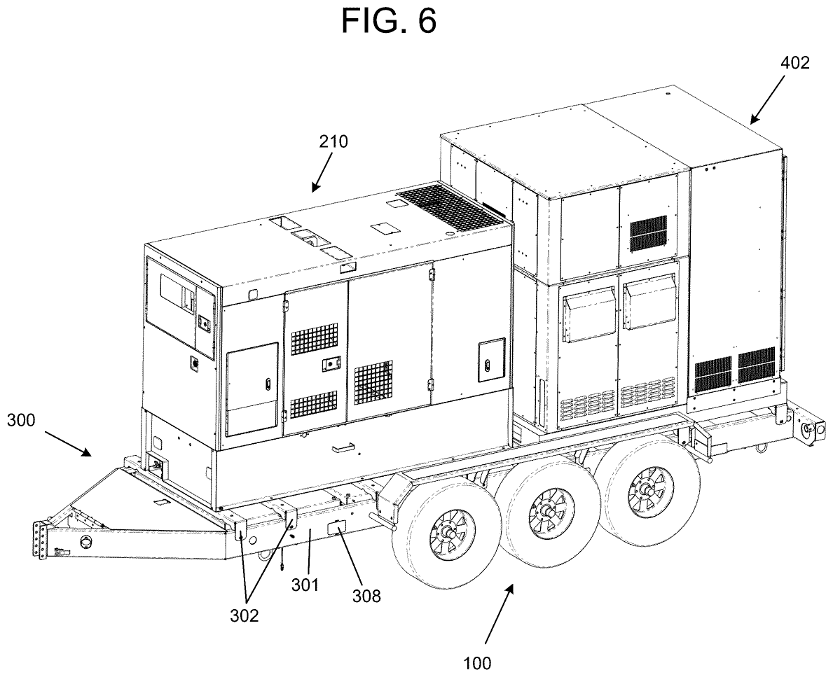

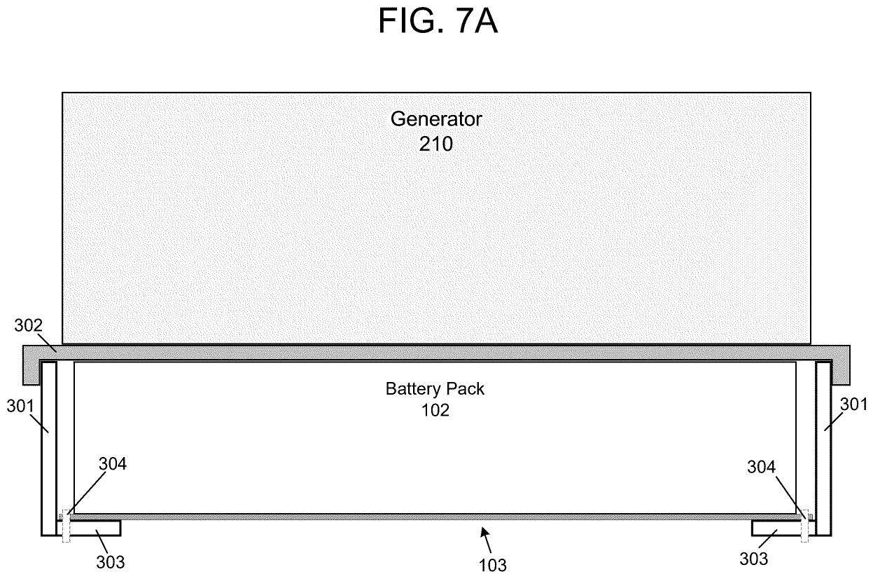

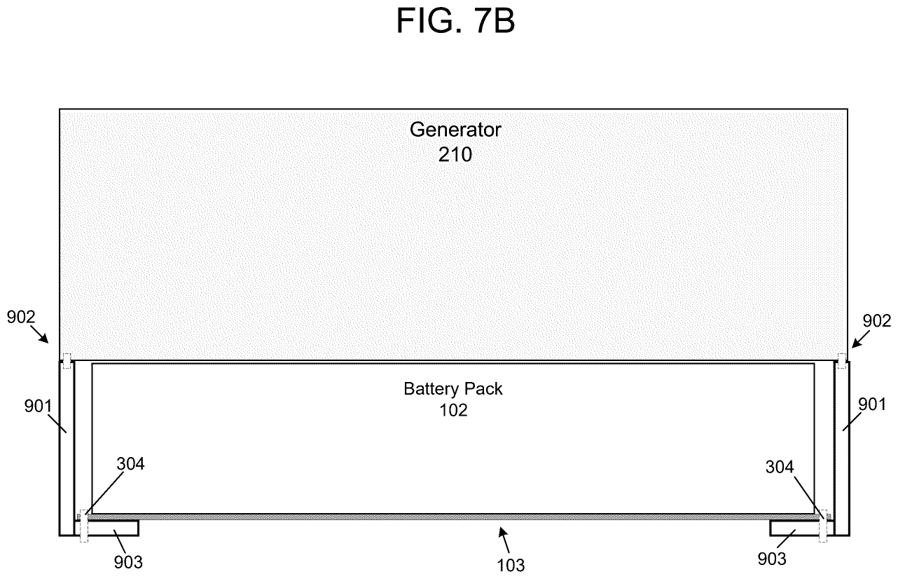

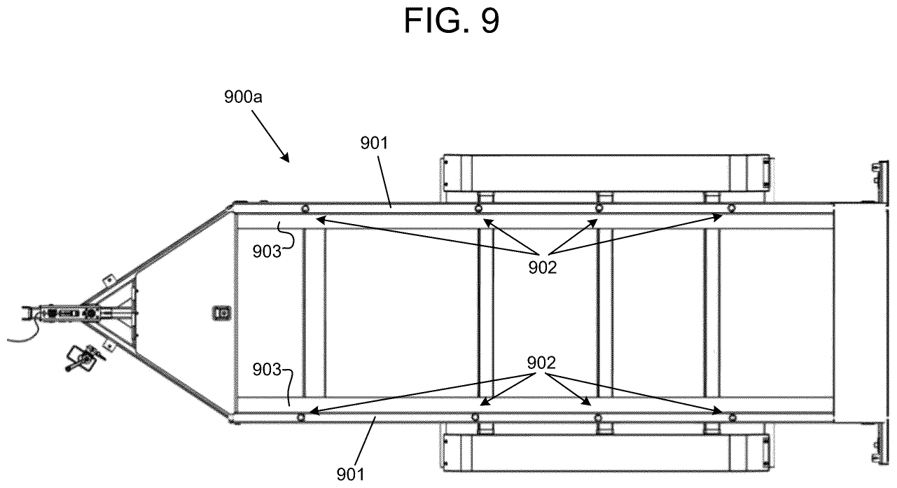

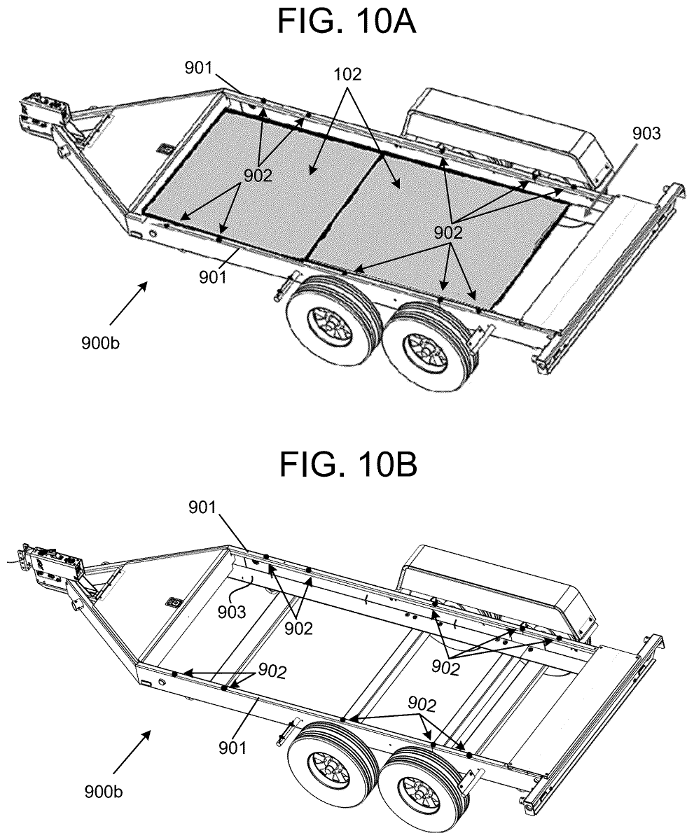

Referring to FIGS. 7B, 9, 10A, and 10B, an alternative trailer frame (e.g., trailer frame 900a, 900b) is configured such that no mounting brackets (e.g., the mounting brackets 302 of FIG. 7A) are needed, as a generator (e.g., generator 210 of FIG. 7B) and any alternative generator/energy storage and/or head unit 402 (see FIG. 6) arrangement are configured to sit directly on the top of exemplary side rails 901 of the trailer frame (e.g., trailer frame 900a, 900b). That is, as illustrated in FIG. 7B, a spacing between the side rails 901 is selected such that a selected generator 210 can be directly mounted to the side rails 901 of the trailer frame (e.g., trailer frame 900a, 900b). When the generator 210 is placed upon the side rails 901, mounting hardware can be used to mount the generator 210 (and any associated hardware) directly to the side rails 901 via an arrangement of mounting points 902 (each configured to receive the mounting hardware). A desired arrangement of mounting points 902 can be arranged along the side rails 901 to fit the desired generator footprint (e.g., for a desired hole pattern on the side rails 901). For example, trailer frame 900a of FIG. 9 includes an exemplary arrangement of four (4) mounting points 902 on each side rail 901, while trailer frame 900b of FIGS. 10A and 10B includes an arrangement of five (5) mounting points 902 on each side rail 901. It is understood that either the generator (e.g., generator 210) and/or the trailer frame 900a, 900b are configured such that the generator 210 will securely sit upon (and be retained upon) both of the side rails 901 (see FIG. 7B).

Referring to FIG. 6, in one exemplary embodiment, the trailer frame 300 and the generator 210 (and accompanying head unit 402) would be sized together, such that the length of the trailer frame 300 would be matched to fit the length of the generator 210 and the head unit 402. Thus, based on the length of the trailer frame 300, a given number of battery packs 102 can be arranged in the trailer frame 300. As illustrated in FIG. 4, a particular trailer frame 300 can be sized to accommodate two or more battery packs 102. FIG. 4 illustrates two battery packs 102 arranged between the trailer frame side rails 301. As illustrated in FIGS. 4, 6, and 7A, an appropriate arrangement of mounting brackets 302 will secure the generator 210 to the trailer frame 300. Note that the mounting brackets 302 and their spacings are selected based on the selected trailer 300 and generator 210 (and head unit 402) selection. Note that the size of the head unit 402 can be dependent upon the capacity of the battery pack(s) 102 and the expected AC power output to an external load.

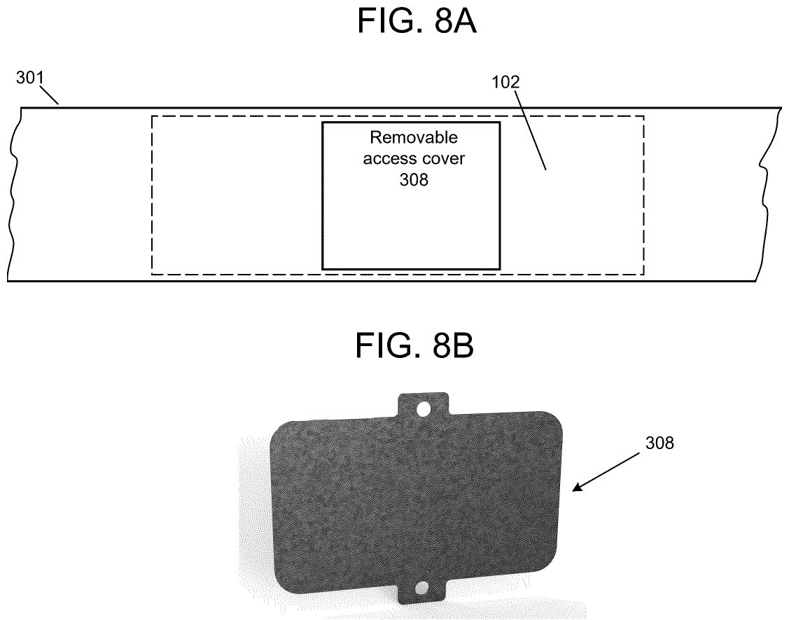

As illustrated in FIGS. 8A and 8B, removable access covers 308 along the trailer frame side rails 301 allows for connection point access, as well as when desired, access to access ports and sensor connections 106, 107 along the length of the battery pack 102 (see FIGS. 1B, 1C, 2B, and 2C). While FIG. 8A illustrates one trailer frame side rail 301 with a removable access cover 308, both trailer frame side rails 301 of a trailer frame 300 may be equipped with the removable access covers 308. As illustrated in FIG. 4, two or more battery packs 102 can be arranged between the trailer frame side rails 301, with the battery packs 102 daisy chained together. In one embodiment, multiple removable access covers 308 can be arranged along the trailer frame side rails 301 to allow for connection point access to each battery pack 102.

Each battery pack 102 includes an exemplary service disconnect used to disconnect a main circuit when installing or removing the battery pack 102 or during maintenance work. Note that a fast-acting fuse is also included that is used to protect the battery pack 102 in case of external short circuit.

While the exemplary embodiments illustrated include battery packs that are arranged in single layers, in an alternative embodiment, the battery packs 102 can be stacked. In one embodiment, a frame for mounting a stack of battery packs 102 can be positioned on the trailer frame 300. The battery pack frame can be arranged such that the stacked battery packs 102 are arranged under the generator 210 (and head unit 402) or separated from the generator 210. In one embodiment, the battery pack frame can accommodate 1-4 battery packs 102. In one embodiment, the battery pack frame includes, or is incorporated with, the trailer frame side rails 301, such that the generator 210 can be arranged with respect to the battery pack frame (and the arrangement of battery packs 102).

As illustrated in FIG. 6, in one embodiment, the trailer frame 300 is also configured to retain and support a head unit 402. An exemplary head unit 402 contains inverters, power electronics and controls, and controls and manages the operation of the generator and the battery system 100. In one embodiment, the head unit 402 is a main component of a battery energy storage system (BESS) that drives and controls all functions. The exemplary head unit 402 receives power from either the generator 210 or the battery pack(s) 102 and outputs AC power (via inverters) to an external load. The head unit 402 will be sized for the expected external load and the battery pack capacity. The head unit 402 may also include battery controllers for controlling the charge/discharge cycles of the battery packs 102 when the generator 210 is running (i.e., power output from the generator 210 can be used to charge the battery packs 102). Power received at the head unit 402 from other sources (e.g., shore power, external batteries, renewable power sources (e.g., wind and solar), and other auxiliary power sources) may also be used to charge the battery packs 102. In one embodiment, when the battery pack(s) 102 are fully charged, the battery pack(s) 102 will power the head unit 402 (such that the generator 210 may be turned off). When the battery pack(s) are depleted (or below a set threshold), the generator 210 may be turned on to power the external load and to recharge the depleted battery pack(s) 102.

Exemplary trailer frame mounting rails 903 of trailer frame 900a, 900b are configured to receive and support an arrangement of battery packs (e.g., the battery packs 102 arranged on the trailer frame 900b of FIG. 10A). The trailer frame mounting rails 903 of the trailer frame 900a, 900b are similar to the trailer frame mounting rails 303 of the trailer frame 300 of FIGS. 4 and 6. Thus, when one or more battery packs 102 are arranged on the trailer frame mounting rails 903 of the trailer frames 900a or 900b, the battery pack height is configured such that the battery pack 102 will not exceed the height of the side rails 901 (see FIG. 7B). In other words, the trailer frame 900a, 900b is configured for directly mounting a generator 210 upon the side rails 901 without being obstructed by one or more battery packs 102 mounted below on the mounting rails 903 (see FIGS. 7A and 7B).

It is understood that additional features from the trailer frame 300 described herein may also be found on the trailer frame 900a, 900b. For example, exemplary embodiments of the trailer frame 900a, 900b may include, or be configured to include the removable access cover(s) 308 illustrated in FIGS. 8A and 8B. Other examples include battery packs 102 fitted, or configured, with cross members 103.

Thus, the exemplary embodiments described herein provide for a low-profile battery system for mounting within a trailer frame configured for mounting a generator. The low-profile battery system may be mounted between side rails of the trailer frame, with the top surface of the low-profile battery system not extending above the height of the side rails. The low-profile battery system includes one or more battery packs that are arranged side by side along the trailer frame. The trailer frame is configured to receive and retain the generator upon the trailer frame (e.g., upon the trailer frame side rails). In one embodiment, the generator is directly mounted upon the trailer frame side rails, while in an alternative embodiment, the generator is mounted to the trailer frame with the use of mounting brackets between the trailer frame side rails and the generator. With the battery pack arranged between the trailer frame side rails, the battery pack provides a low center of gravity for the trailer frame, and the trailer frame side rails provide an additional level of protection for the battery pack.

Changes and modifications in the specifically described embodiments can be carried out without departing from the principles of the present invention which is intended to be limited only by the scope of the appended claims, as interpreted according to the principles of patent law including the doctrine of equivalents.

1. A trailer mounted battery system comprising:
a trailer frame comprising a pair of side rails; and
a low-profile battery configured to mount upon the trailer frame, wherein the trailer frame is configured to retain and support a generator above the low-profile battery;
wherein the low-profile battery is configured to mount between the side rails of the trailer frame, and wherein a height of a top surface of the low-profile battery is lower than or equal to a height of a top surface of the side rails of the trailer frame;
wherein the low-profile battery comprises one or more battery packs, and wherein the battery packs are arranged along the trailer frame and between the side rails of the trailer frame; and
wherein the trailer frame is configured to receive and retain a generator upon the trailer frame.

2. The trailer mounted battery system of claim 1, wherein each side rail of the trailer frame includes at least one removable access cover configured to provide access to the battery packs.

3. The trailer mounted battery system of claim 1 further comprising a plurality of generator mounting brackets arranged across the sides rails of the trailer frame such that the generator mounting brackets are arranged upon the top surfaces of the side rails of the trailer frame, and wherein the generator mounting brackets are configured for mounting the generator to the trailer frame via the generator mounting brackets.

4. The trailer mounted battery system of claim 1, wherein each of the side rails of the trailer frame comprise mounting rails along a respective bottom edge and are configured for mounting battery packs to the trailer frame, and wherein the battery packs are configured to mount to the trailer frame via the mounting rails.

5. The trailer mounted battery system of claim 4, wherein the battery packs comprise respective sets of cross members, and wherein the cross members are configured such that the battery packs are mounted to the mounting rails via the respective sets of cross members.

6. The trailer mounted battery system of claim 1 and further comprising a head unit mounted on the trailer frame and configured to receive power from both the generator and the low-profile battery, wherein the head unit is configured to facilitate the recharging of the low-profile battery and to output power from the generator and/or the low-profile battery.

7. The trailer mounted battery system of claim 1, wherein the side rails of the trailer frame are configured for receiving and mounting the generator to the trailer frame via the side rails, and wherein the side rails of the trailer frame are configured such that the generator is directly mounted to the trailer frame via the side rails.

8. The trailer mounted battery system of claim 1, wherein the battery packs are arranged in a single layer along the trailer frame.

9. The trailer mounted battery system of claim 1, wherein the battery packs are arranged in layers along at least a portion of the trailer frame.

10. A trailer mounted battery system comprising:
a trailer frame comprising a pair of side rails; and
a battery configured to mount upon the trailer frame;
wherein the battery is configured to mount between the side rails, wherein the side rails comprise respective battery mounting rails along respective bottom edges of the side rails and are configured for mounting the battery to the trailer frame, and wherein the battery is configured to mount to the trailer frame via the battery mounting rails; and
wherein the trailer frame is configured to retain and support a generator atop the side rails such that the generator, when mounted upon the trailer frame, does not physically contact the battery.

11. The trailer mounted battery system of claim 10, wherein the battery comprises a set of cross members, and wherein the cross members are configured such that the battery is mounted to the battery mounting rails via the set of cross members.

12. The trailer mounted battery system of claim 10, wherein a height of a top surface of the battery is lower than or equal to a height of a top surface of the side rails.

13. The trailer mounted battery system of claim 12, wherein the trailer frame is configured to retain and support the generator above the battery.

14. The trailer mounted battery system of claim 10 further comprising a plurality of generator mounting brackets arranged across the side rails such that the generator mounting brackets are arranged upon the top surfaces of the side rails, and wherein the generator mounting brackets are configured for mounting the generator to the trailer frame via the generator mounting brackets.

15. The trailer mounted battery system of claim 10, wherein the side rails are configured for receiving and mounting the generator to the trailer frame via the side rails, and wherein the side rails are configured such that the generator is directly mounted to the trailer frame via the side rails.

16. The trailer mounted battery system of claim 10 and further comprising a head unit mounted on the trailer frame and configured to receive power from both the generator and the battery, wherein the head unit is configured to facilitate the recharging of the battery and to output power from the generator and/or the battery.

17. The trailer mounted battery system of claim 10, wherein each side rail includes at least one removable access cover configured to provide access to the battery.

18. The trailer mounted battery system of claim 10, wherein the battery comprises one or more battery packs, and wherein the battery packs are arranged along the trailer frame and between the side rails.

19. The trailer mounted battery system of claim 18, wherein the battery packs are arranged in a single layer along the trailer frame.

20. The trailer mounted battery system of claim 18, wherein the battery packs are arranged in layers along at least a portion of the trailer frame.
